(19) United States
(12) Patent Application Publication
(10) Pub. No.: US 2026/0243653 A1
(43) Pub. Date: Aug. 20, 2026

(54) INTERFEROMETRIC MICROSCOPY

(71) Applicant: Holtra AB, Göteborg (SE)

(72) Inventors: Fredrik Eklund, Göteborg (SE); Erik Olsén, Mölndal (SE); Daniel Midtvedt, Romelanda (SE)

(21) Appl. No.: 19/162,643

(22) PCT Filed: Mar. 6, 2024
(86) PCT No.: PCT/SE2024/050210

§ 371 Date: Sep. 5, 2025

(30) Foreign Application Priority Data
Mar. 6, 2023 (SE) 2330113-8

(51) Int. Cl. G01N 15/1434; G01N 15/0227

(52) U.S. Cl. CPC G01N 15/1434; G01N 15/0227

(57) ABSTRACT

Method and system for characterizing submicron and/or nanoparticles by the use of subwavelength interferometric microscopy, the method comprising illuminating a sample comprising at least one particle and determining a first parameter indicative of scattering cross section of the at least one particle from a detected first portion of light and determining a second parameter indicative of scattering cross section of the at least one particle from a detected second portion of light.

### FIELD OF THE INVENTION

The invention relates to a method and system for characterizing submicron and/or nanoparticles by the use of subwavelength interferometric microscopy.

### BACKGROUND OF THE INVENTION

Interferometric microscopy may be used for detecting and characterising small particles such as submicron particles and nanoparticles. Interferometric microscopy here broadly means microscopy methods which utilize the principle of interference of light to enhance contrast and/or extract more optical information than in conventional microscopy methods. Devices and methods using interferometric microscopy are for example disclosed in WO 2022/123 064 A1 and WO 2022/123 065 A1. These documents disclose the use of a Digital Holographic Microscope (DHM) for characterizing particles. The DHM comprises a spatial filter in order to reduce the intensity of unscattered in order to improve the detectability of light scattered by a particle. However, even though WO 2022/123 064 A1 and WO 2022/123 065 A1 disclose working methods and devices for characterization of particles, there is still a desire for improved methods and devices for characterization of particles of nano and submicron sizes.

### SUMMARY

The invention relates to a method for characterizing submicron and/or nanoparticles by the use of subwavelength interferometric microscopy.

According to a first aspect of the invention, it is provided a method for characterizing submicron and/or nanoparticles by the use of subwavelength interferometric microscopy, the method comprising: illuminating a sample comprising at least one particle by light from a first light source in order to produce scattered light from the particle whereby a first portion of scattered light propagating from the at least one particle in a direction being deflected by an angle α relative the propagation direction of the incident light is directed towards a first detector; using light from said first light source or a second light source for illuminating the sample in order to produce scattered light from the at least one particle whereby a second portion of scattered light propagating from the particle in a direction being deflected by an angle β relative the propagation direction of the incident light is directed towards the first detector or a second detector, and the absolute value of said angle α and the absolute value of said angle β differ by at least 30 degrees, and said first portion of scattered light is interfering with light originating from the first light source which is used to produce the first portion of scattered light when the first portion of light is detected at the first detector and said second portion of scattered light is interfering with light originating from the same light source which is used to produce the second portion of scattered light when the second portion of light is detected at the first or second detector; and determining a first parameter indicative of scattering cross section of the at least one particle from the detected first portion of light and determining a second parameter indicative of scattering cross section of the at least one particle from the detected second portion of light.

Nanoparticles are typically defined as particles that range in size from approximately 1 to 100 nanometres in diameter while submicron particles typically are defined as particles ranging from 10 nanometres to 1000 nanometres, i.e. up to 1 micrometre. Hence, the size of the particles to be characterized are in the size range from 1 nanometre to 1000 nanometres. In particular, the method is suitably used for particles being in the range from 50 to 500 nanometres.

The term subwavelength is used to describe an object having one or more dimensions smaller than the length of the light wave with which the object interacts. The method is thus directed to the use of microscopy for characterizing particles having a size which is smaller than the wavelength of the illuminating light used in the microscope.

The term optically determined diameter/radius/size is used to describe a method which use the properties of detected light from one or several captured images to determine the size of a particle, in contrast to methods which make use of the Brownian motion of a particle to determine its size. The term hydrodynamic diameter/radius/size is used to describe a diameter/radius/size from a size estimation which is based on measuring the Brownian motion of a particle.

Concerning the liquid medium, particles dispersed in water are most commonly analysed, but particles dispersed in a wide variety of different liquids can be analysed. The method may for example be used for characterizing particles within a cell wherein the cytosol is the liquid in which different particles of interest may be studied. Cytosol is the gelatinous liquid that fills the inside of a cell which is composed of water, salts, and various organic molecules. The cytoplasm comprises, in addition to cytosol, organelles and other particles which in many cases are of interest to be studied.

By particles is meant to include a wide variety of different substances and the term is meant to include clusters or agglomerates comprised of same or different molecules or subparts to form the particle. Gaseous bubbles can also be considered as particles in a liquid media. In a broad interpretation of the term particle, any concentrated substance comprised in the liquid having a refractive index differing from the refractive index of the liquid can be considered to be a particle, e.g. oil droplets in an aqueous solution. However, in most cases the particles consist of or at least comprise a rigid supporting structure.

Interferometric microscopy is an imaging technique that uses the principles of interferometry to produce high-resolution images of surfaces and structures. Interferometry involves the interference of light waves to generate patterns of constructive and destructive interference, which can be used to measure the shape and properties of surfaces and structures. In interferometric microscopy, a beam of light is directed towards a sample and there will be light scattered from a particle comprised in the sample. The light scattered by the particle will interfere with unscattered light originating from the same light source, e.g. by splitting the light beam into two separate beams such that one beam is directed towards the sample and the other beam is directed to bypass the sample whereafter the two beams are recombined to interfere. Another way of arranging interference is to use a portion of unscattered light from the light beam directed to the sample, i.e. light which not is affected by any particles in the sample, to interfere with light scattered by a particle in the sample. Hence, subwavelength interferometric microscopy means that light having a wavelength being longer than the size of the particles to be detected is used and light scattered by a particle interferes with unscattered (reference) light from the same light source such that a resulting interference pattern is used to generate an image of the particle.

The method comprises the following features:
Illuminating a sample comprising at least one particle by light from a first light source in order to produce scattered light from the particle. When the light reaches the particle or particles, there will be light scattered in all directions from the particle or particles which are exposed to the light. Since light will be scattered in all directions from a particle, there will be a first portion of scattered light propagating from the particle in a direction being deflected by an angle α relative the propagation direction of the incident light. This first portion of light will be directed towards a first detector.
Using light from said first light source or illuminating the particle by light from a second light source in order to produce scattered light from the particle. There will be a second portion of scattered light propagating from the particle in a direction being deflected by an angle β relative the propagation direction of the incident light. This second portion of light will be directed towards the first detector or a second detector.
Setting the angles such that the absolute value of said angle α and the absolute value of said angle β differ by at least 30 degrees. The angles α and β are defined such that they are 0 if there is no deflection, i.e. for scattered light following the same direction as the incident light. In case the light is deflected clockwise, the deflection angle will be between 0 and 180 degrees where 90 degrees will correspond to clockwise deflection at right angle relative the direction of incident light and 180 degrees corresponds to scattered light moving in the opposite direction to the incoming light. In case the light is deflected counter clockwise, the deflection angle will be between 0 and −180 degrees and −90 degrees will correspond to counter clockwise deflection at right angle relative the direction of incident light.
Arranging said first portion of scattered light to interfere with unscattered light originating from the first light source which is used to produce the first portion of scattered light when the first portion of light is detected at the first detector. Likewise, said second portion of scattered light is interfering with unscattered light originating from the same light source which is used to produce the second portion of scattered light when the second portion of light is detected at the first or second detector. The unscattered light to be used as reference light can for example be a reference light beam which is produced by dividing the light beam used to illuminate the sample upstream of the sample and use one of these beams as a reference beam and bypassing the sample. In another way, unscattered light from the light directed to the sample can be used as a reference beam.
Determining a first scattering cross section of the particle from the detected first portion of light and determining a second scattering cross section of the particle from the detected second portion of light. A scattering cross-section, σ, is a quantity proportional to the rate at which a particular radiation-target interaction occurs. More specifically, if the incoming radiation is considered as being composed of quanta or ‘particles’ which in this case are photons, a cross-section is a scattering rate (number of scattering events per unit time) per unit incident radiation flux, where the latter is the number of incident particles striking the target surface per unit time per unit area. In cases where the radiation is being treated as a continuous classical wave, as in the case of long-wavelength electromagnetic radiation, scattering cross-sections are determined by dividing the power of the scattered wave by the intensity of the incident wave. Dimensionally, a cross-section represents an area. The scattering cross section is a measure of how likely it is for a particle to scatter off another particle or a target. It is defined as the effective area presented by the target that interacts with the incoming light wave. The scattering cross section is usually denoted by the symbol σ and has units of area. The scattering cross section depends on various factors, such as the energy of the incoming particles, the material and mass of the particles, and the nature of the target. The scattering cross section can be calculated using the following formula:

$${σ}_{0} = ( ( 4 * k ) / ( 2 * π ) ) * {\vert α \vert}^{2}$$

where k=2*π/λ, λ is the wavelength of light, α is the polarizability of the particle. σ₀ is the scattering cross section at 0 degrees, and need to be adjusted using the form factor to get the scattering cross section for other scattering angles. The scattering cross section can be estimated from different measured parameters depending on the type of interferometric microscopy used. Different parameters indicative of scattering cross section can thus be used in the further analysis.
Estimating a form factor of the particle by using the ratio of the first parameter indicative of scattering cross section derived from the first portion of scattered light and the second parameter indicative of scattering cross section derived from the second portion of scattered light. In the context of scattering experiments, the form factor is a measure of how the scattering amplitude, which describes the interaction between the incident light and the particle, varies with the momentum transfer between the light and the particle. The form factor is related to, in addition to size, refractive index and scattering angle, the internal structure of the particle and provides information about the distribution of material and mass within the particle. The scattering cross section, or a related parameter, for a specific scattering angle, σ, can be used to calculate form factor f. The scattering cross section at a specific angle is defined as the product of the scattering cross section go and the square of the form factor f. It is given by the formula:

$$σ = {σ}_{0} * {\vert f \vert}^{2}$$

Estimating an optically determined diameter Dₒₚₜ of the particle based on the form factor in combination with simulations or calculations based on, or in accordance with, optical theory, such as Mie theory. By measuring the scattering cross section at different angles, and possibly also use different energies (wavelength) of the incident light, and analysing the data using models that incorporate the form factor, detailed information about the distribution of material and mass within a particle can be obtained, and the size and shape of particles and other microscopic structures can be determined. The relationship between particle size and scattered intensity at any given scattering angle is complex and is fully defined for spherical particles of any size by Mie Theory. Depending on the scattering angle as well as the size of the particle relative to the wavelength of the incident light there are simplifications which may be used to relate particle size to scattered intensity. However, such simplifications have been found to be valid when the size of the particles are significantly larger than the wavelength of the illuminating light, e.g. simplified geometric scattering, or when the size of the particles are at considerably smaller than the wavelength, e.g. Rayleigh scattering. However, even though the particles in this case are smaller than the wavelength of the light used, the size of the particles to be detected is still of the same magnitude or one magnitude smaller and Mie theory is therefore suitably used in the analysis.

The microscope set-up may include one or two light sources and one or two detectors. When two light sources are used, these light sources are preferably designed to provide light at different wavelengths in order to distinguish the different light sources. The use of light at different wavelengths is in particular useful when the sample is illuminated from two different illumination points by separate light sources.

Hence, the use of interferometric microscopy at different angles enables estimation of a variety of properties of the particles which are analysed in the microscope. To obtain different angles in the microscope may be achieved by different ways. According to one design of the microscope, there is a single light source illuminating the sample from a single point. The incident light will be scattered by the particle and there will be a first and second detector located such that the absolute value of the angles differs by at least 30 degrees.

According to another design of the microscope, there are two different light sources used which are designed to provide illuminating light, preferably having different wavelengths in order to keep the light from the different sources separated. In this case, the illumination points of the different light sources can be located to be separated by at least 30 degrees (absolute value) and share a common detector. Alternatively, two detectors may be used and the first detector shall be located at an angle α relative the incident light from the first light source and the second detector shall be located at an angle β relative the incident light from the second light source, the absolute value of angle α differing by at least 30 degrees compared to the absolute value of angle β. The two light sources could also be located in parallel and arrange the first and second detector to be separated such that the absolute value of the angles α and β differs by at least 30.

In order to increase the difference in scattering intensity from the first portion of light and the second portion of light, the difference between the absolute value of angle α and the absolute value of angle β is at least by 60 degrees, more preferably at least 90 degrees.

The absolute value of angle α for the first portion of scattered light could be set to be between 0 and 20 degrees and the absolute value of angle β for the second portion of light could be set to be between 100 and 180 degrees, preferably between 150 and 180 degrees. This is for example the case when the sample is imaged in essentially straight transmission angle, i.e. the angle of the scattered light to be detected is close to 0 degrees relative the illumination light, and backscattering angle, i.e. the angle of the scattered light to be detected is close to 180 degrees relative the illumination light. In such an arrangement, the sample could be imaged by digital holographic microscopy for the portion of light scattered in transmission and could be imaged by interferometric scattering microscopy in the portion of light which is backscattering.

Digital holographic microscopy is a group of methods, with the ability to reconstruct the complete optical field of a particle or object. The optical complex optical field comprise information on both the phase and the intensity of light which has interacted with the particle and the intensity is affected both by scattering and absorption of light. A general feature of digital holographic microscopy is that background illumination light which has not interacted with the particles is by some technical means split into two or more portions which interfere with each other. A device used in performing digital holographic microscopy can be described as follows:

A digital holographic microscope, DHM, comprises
A coherent light source for creating a base light beam for illuminating a sample in a first image plane,
A sample holder for holding a sample in the image plane to be illuminated,
A detector, e.g. a camera, arranged to record images of light transmitted through a sample in the sample holder,
A an optical component for dividing the base light beam into different portions and causing the different portions of the light beam to interfere with each other at the detector.

Interferometric scattering microscopy (ISCAT) is a method where light scattered by the particle interferes with unscattered light which has traveled the same optical path from the sample to the detector. The common implementation of the method utilizes light back-reflected by the interface between the sample holder (which often is a simple glass cover slip) and the liquid medium, as reference for the scattered light to interfere with. Instead of a coverslip, a micro- or nanofluidic channel or chamber may be used. The method can quantify the scattered light from a particle, but does not quantify the full optical field. It is also possible to implement the method by directing light from a different angle than from the direction of the detector (150-180 degrees) to interact with the sample and sample holder.

The method may be used to differentiate between particles of different morphology. In addition to estimate an optically determined diameter Dₒₚₜ of the particle, also a hydrodynamic diameter D_{hyd} can be determined. Dₒₚₜ can be determined by using the form factor with the help of a Mie simulation and assumption of the geometry of the particle. In many cases, it is assumed the particle is a homogeneous sphere but there may of course be other assumptions used if another particular geometry and/or morphology of a particle is expected. The hydrodynamic diameter D_{hyd} can be determined from the Brownian motion of the particle. The ratio between these two diameters can be used to differentiate between particles of different morphology. The Brownian motion is typically analyzed by determining the position of a particle in several consecutive image frames and based on the distance it has moved between these frames, estimating its diffusivity. From diffusivity, temperature and liquid viscosity, the hydrodynamic diameter of a particle can then be calculated with the help of the Stokes-Einstein relation. The diffusivity can be determined based on the motion on in one, two or three dimensions. For particles in flow, the diffusivity is most commonly determined based on movement in dimensions perpendicular to the flow direction.

The method may also be used for categorizing particles into different populations based on their characteristics. In order to perform such a categorization, at least 2 relevant parameters are preferably combined and used to categorize detected particles into particle populations with different population density maxima in the parameter space of said at least two parameters. As an example, two parameters are selected whereof a first parameter is selected from a first group of parameters, parameter group I, comprising:
ratio of parameter indicative of scattering cross section for the first portion of light comprising light scattered at an angle α and parameter indicative of scattering cross section for the second portion of light comprising light scattered at an angle β, and
form factor
optically determined diameter

Likewise, a second parameter is selected from a second group of parameters, parameter group II, comprising:
Hydrodynamic diameter
Parameter indicative of scattering cross section for either the first portion of light comprising light scattered at an angle α or scattering cross section for the second portion of light comprising light scattered at an angle β
Scattering intensity for either the first portion of light comprising light scattered at an angle α or scattering cross section for the second portion of light comprising light scattered at an angle β
Imaginary part of the complete optical field
Integrated phase shift

The selected parameters from each group are combined and used to categorize detected particles into particle populations with different population density maxima in the parameter space of the selected parameters. If desired, further parameters may be selected from the respective groups. The parameters are preferably selected such that they represent features essential for distinguishing particles of interest in the sample to be categorized into different populations. The hydrodynamic diameter is advantageous to use in parameter group II, since it is an independent parameter in relation to the parameters in group I.

The method described above may for example be used for detection of adsorption of a protein corona on a particle, e.g. a spherical particle. Protein corona refers to the layer of proteins that can adsorb onto the surface of nanoparticles, e.g. when they come into contact with biological fluids, such as blood or serum. The adsorption can be detected by the change in the relation between the hydrodynamic diameter D_{hyd} and optically determined diameter Dₒₚₜ before and after adsorption.

The relationship between the size (diameter, D) of a cluster and the number of monomers (N) can be expressed as its fractal dimension (D_{f}): D∝N\hat{ }D_{f}, i.e. the diameter D is proportional to the number of the monomers N to the power of the fractal dimension D_{f}. For closely packed spheres D_{f}=3, otherwise lower. When D_{f}<3, the larger the cluster the lower its particle/liquid ratio. For this reason, the optically determined diameter of a cluster will be lower than the hydrodynamic diameter and this difference will increase with increasing size although there are exceptions in some size ranges due to local minima in the optical diameters size dependence. Fractal dimension and the relationship between the diameter of a cluster and the number of monomers will be explained further in the detailed description.

The method may also be used for characterization of dielectric particles labelled with plasmonic nanoparticles, e.g. gold nanoparticles. Gold nanoparticles are suitably used since they are resonant and strongly absorbing at a first wavelength (for example green) used for the light source for the first portion of light while being non-resonant and weakly absorbing at a second wavelength (for example red) used for the second light source for the second portion of light.

Holographic microscopy is suitably used for the first portion of light and interferometric scattering microscopy for the second portion of light. The first portion of light may be used for determining the optical field of the particle. By using light sources of different wavelengths for the first and second portions of light, and specifically using light adapted to the resonance and absorption properties of the plasmonic nanoparticles, facilitate to distinguish labelled particles from other particles and particle complexes by the use of the optical field. Furthermore, the imaginary part of the optical field can be used as an approximation for the amplitude of the optical field of the dielectric particle less the attached plasmonic nanoparticle to estimate the scattering cross section of the dielectric particle less the attached plasmonic nanoparticles. The scattering cross section may in turn be used to determine an optically determined diameter Dₒₚₜ for the particle less the attached plasmonic particle.

A population of particles labelled with plasmonic nanoparticles may thus be differentiated from other particles and particle complexes using the optical field together with ratio of the signal originating from the second portion of light, e.g. by using iSCAT, and absolute value or imaginary part of the optical field originating from the first portion of light, to determine particle size and optionally, equivalent mass.

There are several different fields of use for the method described above. Differentiating different particle types in a heterogeneous dispersion is of interest for example in waste water analysis, or when analyzing biological samples such as serum, or in quality control and characterization of biological pharmaceuticals. According to one example, the method is used for differentiating extracellular vesicles from protein aggregates and/or lipoproteins in biological samples or in preparations of extracellular vesicles or proteins. Still further examples are to differentiate viable virus particles from virus debris and protein aggregates and/or extracellular vesicles or to differentiate protein aggregates from other particle types.

According to a second aspect of the invention, it is provided a subwavelength interferometric microscopy system for characterizing submicron and/or nanoparticles, the system comprising: at least one light source configured to illuminate a sample comprising at least one particle to produce scattered light from the particle whereby a first portion of scattered light propagating from the at least one particle in a direction being deflected by an angle α relative the propagation direction of the incident light is directed towards at least one detector; the at least one light source being further configured to illuminate the sample in order to produce scattered light from the at least one particle whereby a second portion of scattered light propagating from the particle in a direction being deflected by an angle β relative the propagation direction of the incident light is directed towards the at least one detector, and the absolute value of said angle α and the absolute value of said angle β differ by at least 30 degrees, and said first portion of scattered light is interfering with light originating from a first light source which is used to produce the first portion of scattered light when the first portion of light is detected at the first detector and said second portion of scattered light is interfering with light originating from the first light source or a second light source which is used to produce the second portion of scattered light when the second portion of light is detected at the first or second detector; the system further comprising control circuitry configured to: determine a first parameter indicative of scattering cross section of the at least one particle from the detected first portion of light and determine a second parameter indicative of scattering cross section of the at least one particle from the detected second portion of light.

Effects and features of this second aspect of the present invention are largely analogous to those described above in connection with the first aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates light scattering at a particle;

FIGS. 2A-C schematically illustrate features of light scattering at a particle;

FIG. 3. schematically Illustrates scattering angles of light scattered by a particle;

FIG. 4 schematically Illustrates a Digital Holographic Microscope (DHM) set-up, including components for interferometric scattering microscopy for backscattered light according to an example embodiment;

FIG. 5 schematically Illustrates a Digital Holographic Microscope set-up, including components for interferometric scattering microscopy for backscattered light according to an example embodiment;

FIG. 6 schematically Illustrates a system for coherent brightfield imaging (COBRI) according to an example embodiment;

FIG. 7 schematically Illustrates a relationship between an optically determined diameter and a form factor of a particle;

FIG. 8. schematically Illustrates experimental data and theoretical curves for the relationship illustrated in FIG. 7; and

FIG. 9. schematically Illustrates a theoretical plot of optically determined diameter in relation to hydrodynamic diameter for particles with different mass distribution.

### DETAILED DESCRIPTION

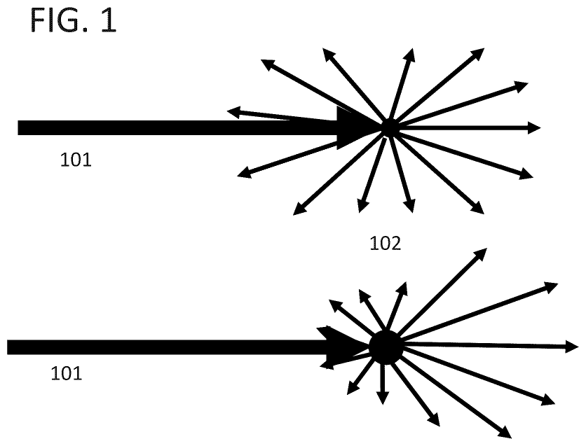

The properties intensity and phase of light scattered by a particle varies with the scattering angle. This angle dependence varies with particle size and thus if light can be collected from different scattering angles, information on particle size can be extracted. The angle dependence is very large for particles larger than the wavelength of light but becomes very small for particles smaller than 1/10 of the wavelength of light. The wider the range of scattering angles that light can be collected from, the smaller the characterizable particles. This principle is illustrated in FIG. 1, where light 101 is directed at a small particle 102 and a large particle 103 from the left and scattered in all directions when interacting with a particle 102, 103 as indicated by arrows. The length of the arrows indicates the intensity of light scattered in different directions. For the small particle 102, with a size smaller than 1/10 of the wavelength, the forward scattering intensity is essentially similar to the backscattering intensity. For the large particle 103, the forward scattering is several times more intense than the backscattering.

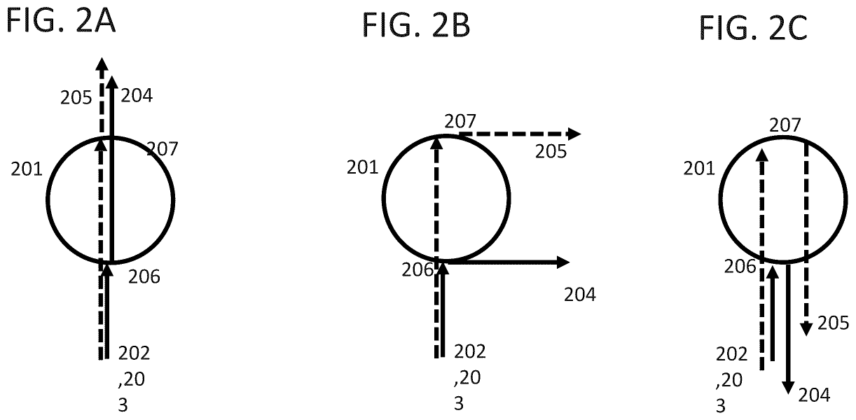

The physical reason for the angular scattering dependence is interference between light which has been scattered at different surfaces of the particle. This is illustrated in FIGS. 2A-C.

Forward scattering from a particle 201 is illustrated in FIG. 2A. A first light wave 202 and a second light wave 203 are directed towards the particle 201. The particle 201 have a first particle surface 206 on the side of the particle 201 facing towards the direction wherefrom the first and second light waves 202, 203 comes and a second surface 207 on the far side of the particle 201. The first light wave 202 is interacting with the first particle surface 206 when they meet and generates a first scattered light wave 204. The second light wave 203 which interacts with the second particle surface 207 on the far side of the particle, generates a second scattered light wave 205. The first scattered light wave 204 and the second scattered light wave 205 will not interfere significantly with each other since they have the same phase since they have traveled the same pathlength. In this case the form factor is approximately 1.

For light scattered at 90 degrees angle as illustrated in FIG. 2B, the maximum difference in pathlength for the first scattered light wave 204 scattered by the first particle surface 206 and the second scattered light wave 205 scattered by the second particle surface 207 is one particle diameter. This will cause the first scattered light wave 204 and the second scattered light wave 205 to be out of phase and thus to interfere with each other.

For backscattered light as illustrated in FIG. 2C, the pathlength difference between the first scattered light wave 204 interacting with the first particle surface 206 and the second scattered light wave 205 interacting with the second particle surface 207 will be two particle diameters and thus the phase difference will be greater than for the 90 degree case as disclosed in FIG. 2B.

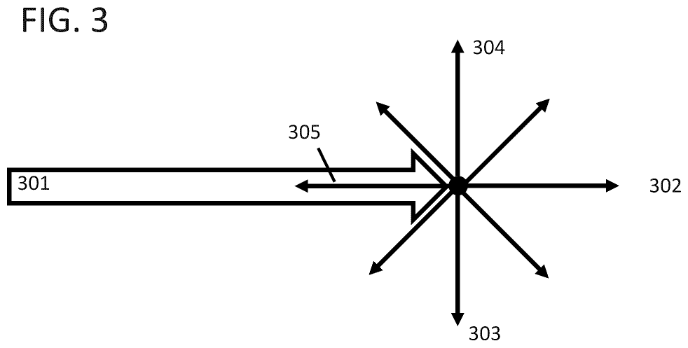

FIG. 3. Illustrates the scattering angles of light scattered by a particle. Incoming light 301 from the left interacts with a submicron size particle 306 and light is scattered in all directions. Forward scattered light 302 is defined as having 0 degrees scattering angle. Light scattered 90 degrees in clockwise direction 303 can be considered to have scattering angle of +90 degrees and light scattered 90 degrees in counterclockwise (opposite) direction 304 can be considered to have a scattering angle of −90 degrees. However, the light scattered both in +90 and −90 degrees have the same properties and for the purpose of this invention it is the absolute value of the scattering angle which is of interest. Backwards scattered light 305 scattered back towards the incoming light 301 has a scattering angle of +−180 degrees.

The scattering dependence can be described by a parameter called the form factor, f. The form factor for a certain scattering angle is dependent on the size of the particle, the internal mass distribution of the particle and is also weakly dependent on the refractive index difference between the particle and the medium. Mathematically, the form factor can be expressed as

$$f = \frac{1}{V} {\int }_{V} {e}^{- i Δ ϕ} d v ,$$

where V=particle volume, Δφ=phase difference of light contributions from subregions of the particle dv.

The optical field of light scattered at a certain angle is proportional to the polarizability of the particle which to a high degree depends on Δn and V, and to the form factor for this angle, f. Here, Δn is the refractive index difference between the particle and the surrounding medium, V is the volume of the particle. The form factor is generally greater for backscattered than for side-scattered light and for forward-scattered light it is approximately 1.

This means that the optical field of the scattered light has a stronger size dependence for backscattering and side scattering than for forward scattering, which could in principle make side- and backscattered light powerful for size determination, this requires however Δn is known and even so it is difficult to disentangle the contribution of Δn and V. Furthermore, the mass distribution of the particle may affect the result. For very small particles, with diameter < 1/10 the wavelength of light, the form factor is close to 1 at any angle and size determination directly from the optical scattering is thus much more straightforward. A further problem with size determination from side- and backscattered light is that its magnitude does not scale monotonously with size. Instead, its size dependence exhibits one or several local minima in the submicron diameter range (0.1-1 micron). The exact position of these minima depends on the wavelength and Δn. These minima are due to the form factor being affected by the relationship between light wavelength and particle size. Practically, this means that a certain optical scattering intensity or field cannot be unambiguously assigned to one single particle size. Methods utilizing forward scattered light do however not suffer from such local minima, the optical scattering intensity scales monotonously with ΔnV.

Using microscopy, each imaging angle does in reality comprise a range of angles, which needs to be taken into account when interpreting the analysis of the recorded images. In the case of forward scattering, the form factor is 1 when the scattering angle is zero and less than 1 when the angle is larger than 0. In a similar way, the back scattering form factor is the lowest for 180 degrees, where the form factor is larger for all other angles. Due to the rotational symmetry, the optical signal does not average such that the mean signal within the collection angles of the objective is best described using 0 or 180 degrees angles. That angle instead depends on the range of collection angles. For examples, when using an oil immersion objective with a numerical aperture of 1.3, the maximum collection angle is 59 degrees. For example, for 200 nm diameter particles, the Mie scattering weighted average angle is 38 degrees. For particle sizes around 200 nm diameter, the average angle changes within 1 degree. For this reason, the theoretical signal ratios use an angle of 38 degrees for the forward scattering and 142 degrees for the back scattering.

An interferometric microscopy method which quantifies backscattered light from particles is iSCAT (interferometric scattering microscopy). This method utilizes light back-reflected by the interface between the sample holder (which often is a simple glass cover slip) and the medium, as reference for the scattered light to interfere with. The optical signal in iSCAT is a combination of two different terms, one which is proportional to the square root of the backscattering cross section and one which is proportional to the backscattering cross section. The proportional term is due to the scattered light directly and the square root term is due to interference. For small nanoparticles, it is common to neglect the proportional term as it is much smaller than the interference term. However, in the size range 0.1-1 micron, both terms can be significant contributors to the measured intensity/contrast. For small enough particles that only the interference contribution is significant, the image brightness contrast of the particle is proportional to \sqrt{σ} and to

$$V Δ {nfe}^{- i \frac{4 π}{λ} Δ z} ,$$

where V=particle volume, Δn=refractive index difference and f=form factor. The last factor is due to the interaction of light scattered by the particle and light scattered by the glass surface, which serves as reference. Δz is the distance between the particle and the glass surface, A is the wavelength. When the particle is focused perfectly, optically or digitally, the last factor can be ignored. For small enough particles it is typically the contrast of the particle in focus which is measured and is a measure of how much light is blocked/extinguished due to scattering. For larger particles, also scattered light is detected. Particle contrast is thus a parameter indicative of scattering cross section for small particles. This is provided the particles have low absorbance, which may otherwise also contribute to light extinction. For particles imaged out of focus, it is suitable to digitally refocus them before analyzing their optical properties.

A group or subset of interferometric microscopy methods is digital holographic microscopy (DHM) which is most often utilized for quantifying forward scattered light. Several such methods have been described in EP2021/085318. One DHM method is off-axis DHM where a separate reference beam of light is interfering with light having been transmitted through the sample. Based on an interference pattern in the image, DHM methods enable the reconstruction of the complete optical field of the particle, including both the phase shift and the intensity of forward scattered light. The amplitude of the optical field is proportional to ΔnV since f is approximately 1. For small dielectric particles, the measured phase shift of light having passed the particle is approximately similar to the imaginary part of the optical field of the particle which is almost similar to the amplitude of the optical field of the particle and these parameters are all indicative of the scattering cross section of the particle. For small dielectric particles with negligible light absorbance, also the light extinction and the real part of the optical field are indicative of the scattering cross section.

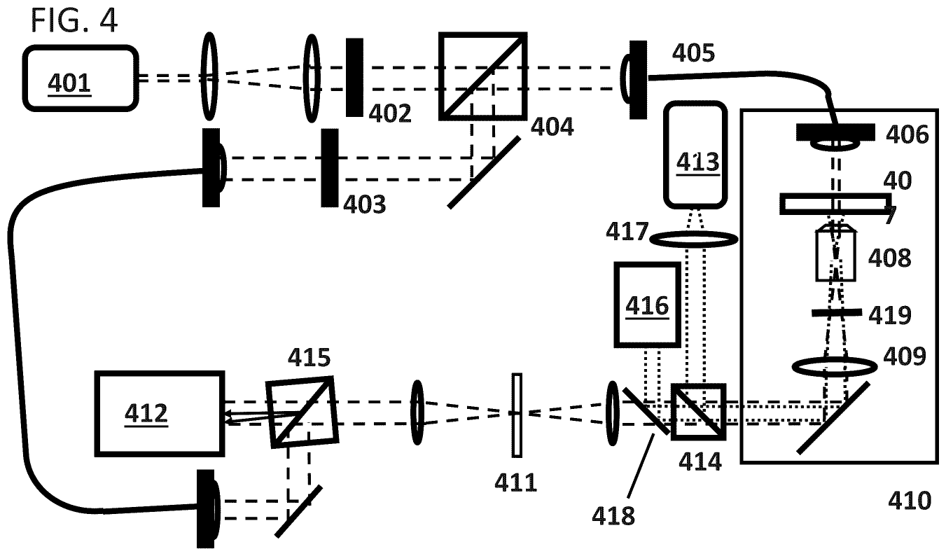

FIG. 4. shows a DHM set-up, with addition of components for interferometric scattering microscopy for backscattered light, according to an embodiment of the invention. FIG. 4 discloses a DHM comprising a coherent light source 401 from which light is guided via first half wave plate 402 to a first beam splitter 404 which divides the light into a first divided beam which will serve as an object beam guided to a sample holder 407 in order to illuminate a sample and a second beam functioning as a reference beam being guided to bypass the sample holder 407 and sample. The reference beam is guided via a second half-wave plate 403 and suitable light guiding means such as mirrors and optical fibres to a second beam splitter 415. The object beam is guided via similar light guiding means including mirrors and an optical fibre 405 to a microscope body 410. In the microscope body, the light is directed to a collimator lens 406 illuminating the sample in the sample holder 407 at a first image plane. Downstream of the sample, the beam passes through a microscope objective 408, a tube lens 409, and via a mirror exits the microscope body 410. The set-up further comprises a double lens arrangement including two lenses and a spatial filter 411, e.g. a disk filter obstructing the central portion of the light beam, in the focal plane between the lenses. The light passes through the double lens arrangement and the spatial filter 411 before it enters the second beam splitter 415 to be reunited with the reference beam before being directed to a camera 412. In the microscope body, the objective 408, tube lens 409 and mirror are positioned to create an image plane at the port where the object beam exits the microscope. The first of the two lenses is placed one focal length (of the lens) from this image plane. Note that FIG. 4. is not drawn to scale and the distance from the first image plane to the first lens is in reality the same as from the second lens to the camera. The filter 411 serves to dampen the background light and thereby improve imaging of subwavelength particles. Furthermore, the set-up comprises an additional light source 413, of a different wavelength than the first light source 401. The light passes one or several lenses 417 in order to expand the beam and provide a desirable degree of collimation of the light. The light is further reflected by a polarization-dependent beam splitter 414 and enters the microscope and follow the optical path “backwards”, being collimated at the image plane, being focused in the internal focal plane of the objective, and again being collimated when illuminating the sample from below. Light reflected by the sample holder, together with light scattered by particles in the sample travels down through the objective and tube lens, passes through the beam splitter and is reflected by a dichroic mirror 418 towards a camera 416. The dichroic mirror is selected such that the backscattering light, originating from light source 413 is reflected whereas the light originating from light source 401 is being transmitted through the mirror due to their different wavelengths. Additionally, there is quarter-wave plate 419 below/behind the objective. This as light first passes this plate in one direction and then on the way back after having been reflected, it is in total rotated 90 degrees. This enables the very most of the light to pass through the beam splitter and this arrangement limits the light losses in the set-up.

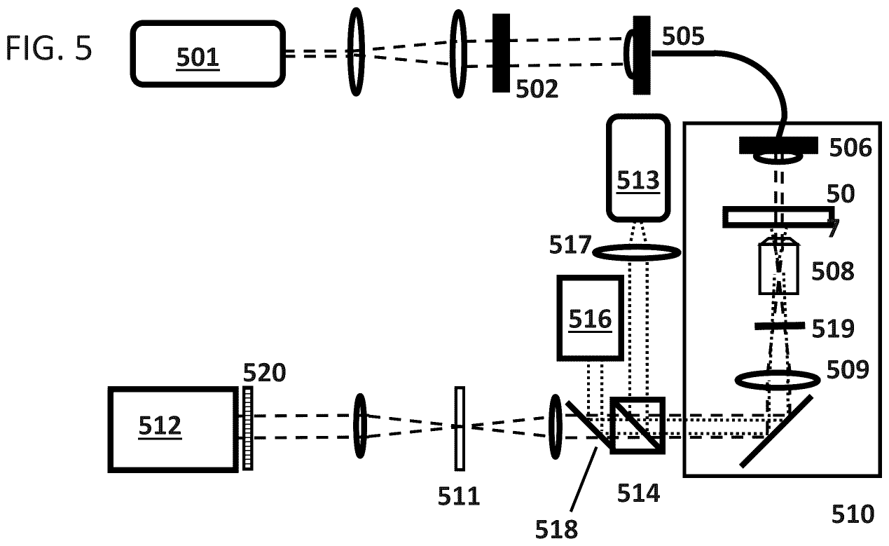

FIG. 5 discloses a DHM setup with addition of components for interferometric scattering microscopy, similar to FIG. 4, but where all light for DHM imaging shares a common path. Unless otherwise indicated, features in FIG. 5 which last two digits of the reference numbers corresponds to the last two digits of the reference numbers in FIG. 4 are indicating the same feature, e.g. 401 corresponds to 501, 402 corresponds to 502 and so on. The filter is placed in the focal plane 511 between the two lenses as in FIG. 4. A grating 520 is placed in close proximity to the camera 512 which is used as detector for DHM. The grating may comprise a 2D pattern where different fields provide a different phase shift of the light, these fields may be separated by opaque lines. Light portions having passed different fields interfere with each other at the detector, generating an interference pattern based on four different diffraction orders. Hence, the grating replaces the need for deflecting a separate reference beam as disclosed in FIG. 4.

One interferometric method for forward scattering is called coherent brightfield microscopy (COBRI), this is essentially DHM but without interference between portions of unscattered background light. It can also be seen as a type of iSCAT for transmitted light. By focusing the illumination light, by illuminating only a small area and also by removing part of the background light with a spatial filter, low detection limit can be achieved. COBRI measures the scattered intensity from a particle in transmission mode. The measured contrast is proportional to the scattering amplitude of the optical field of the particle which is proportional to the scattering cross section for forward scattering.

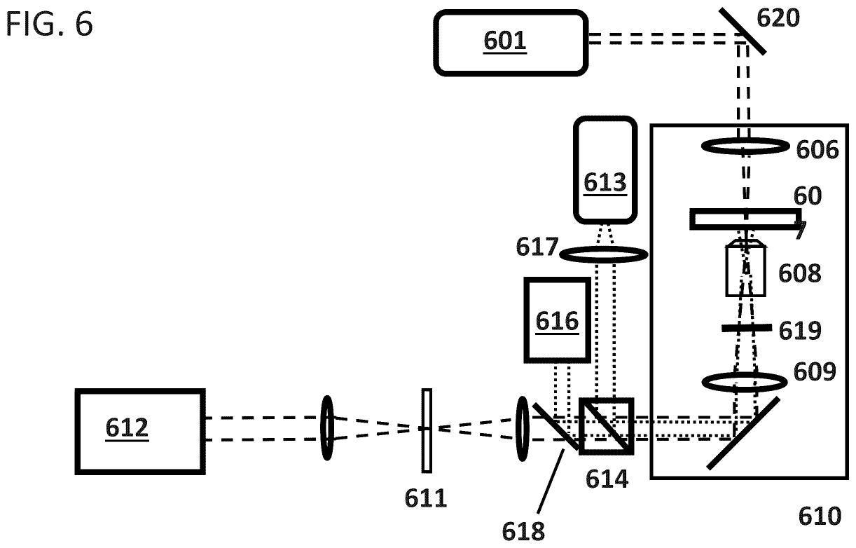

FIG. 6 discloses a setup where the forward/transmission method is an interferometric but not holographic method, coherent brightfield imaging (COBRI). The light source 601 is a coherent source such as a laser. As explained concerning FIG. 5, also features in FIG. 6 which last two digits of the reference numbers corresponds to the last two digits of the reference numbers in FIG. 4 are indicating the same feature unless otherwise indicated, e.g. 401 corresponds to 601, 406 corresponds to 606 and so on. The light is focused by lens 606 to small area in the sample. To achieve a uniform illumination and to illuminate a larger area, a mirror 620 may be a scanning mirror which scans the beam at very high frequency. A spatial filter 611 may still be used to enhance the contrast. Unlike holographic methods, the optical field is not reconstructed, instead the image contrast of the particle is used to read out the scattering amplitude of the particle. The interferometric backscattering (iSCAT) can be used to together with this method to carry out the invention as shown in FIG. 6.

In most DHM methods, there are two interferences; first light scattered by the particle interferes with light having passed though the sample but not interacted with the particle. Secondly different portions of light from the same light source, having passed the sample or not, are cause to interfere, caused some optical component. A special case is darkfield DHM, where no background light which have passed through the sample but not interfered with the particle is allowed to reach the camera sensor. This is achieved either by illuminating the sample at an angle or by illuminating in transmission (forward scatter) and using a spatial filter downstream to remove all the background light. Light from the same light source is passed in a separate reference beam to the camera where it is interfering with light scattered by the particles. Unlike other DHM methods, the complete optical field is not well quantified since the intensity relative to the background is difficult to assess as no background light is measured. However, the scattering intensity can be determined and thus the scattering cross section which in this case is proportional to the scattering intensity. Since darkfield DHM can be applied at different illumination angles, it can be used to realize the dual-angle interferometric microscopy.

As mentioned before, the form factor is dependent on the particle volume. If the volume can be derived from the form factor, a radius can be derived from the volume. This radius will however have a different meaning depending on the mass distribution of the particle. Using Mie simulations and the assumption that the particle is a homogeneous sphere will generate a radius which is similar to the physical radius if the particle actually is a homogeneous sphere. However, if the assumption is incorrect and the particle is in fact a core-shell particle where the shell is optically denser than its core, the estimated diameter will be larger than the physical diameter. Similarly, either a core-shell particle where the core is optically denser than the shell or particle aggregates with a fractal dimension less than 3 will give a diameter that is smaller than the physical diameter. It is important to recall that the optically determined diameter is only uniquely defined for spheres with a diameter smaller than 2-300 nm, whereas in the range where local minima for scattering amplitude as function of size occur, the optically determined diameter may be smaller than the physical diameter for a homogeneous sphere.

Another optical measure of particle size is the radius of gyration, which has a relation to the physical size similar to the optical radius mentioned above. The radius of gyration is a statistical measure of the average distance of the particle's mass from its center of gravity. It is calculated as the root-mean-square distance of each particle element from the center of mass. Practically, the radius of gyration is 0.77 times the physical radius for a homogeneous spherical particle. It is only equal to the physical radius for a hollow core-shell particle with very thin shell. For certain limited parameter ranges, the radius of gyration can be calculated with mathematical formulas, without use of Mie simulations.

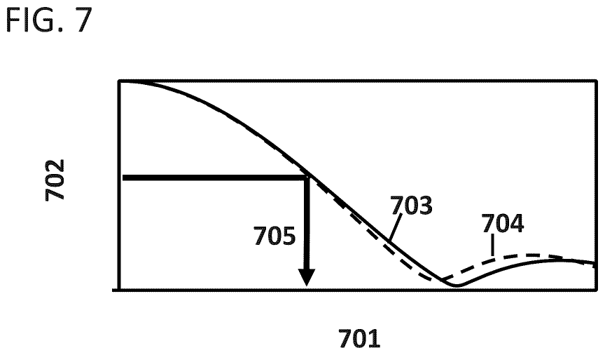

FIG. 7. shows the relationship between the optically determined diameter 701 and the form factor 702 in the diameter range 0-600 nm. The curve 703 shows the relationship for silica particles (refractive index 1.44) and 704 shows the relationship for polystyrene particle (refractive index 1.59). The line/arrow 705 shows how the form factor 702 is used to read out a size 701. The form factor has only a small dependence on refractive index difference and this dependence can often be neglected, especially for smaller particles. However, for larger particles it may be useful to perform an iterative procedure by first determine a size based on an assumed refractive index, then use the size to estimate a refractive index, then make a new size estimate based on the improved estimate of the refractive index.

### Example 1

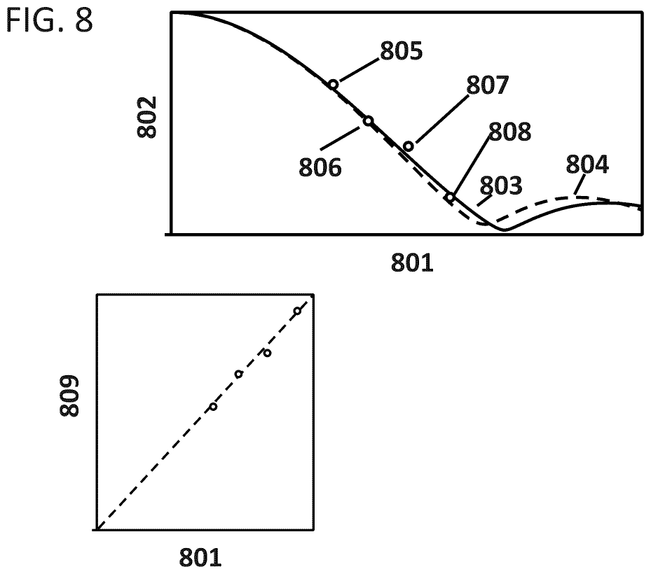

In FIG. 8. is shown experimental data together with the theoretical curves 803, 804 corresponding to the curves 703, 704 from FIG. 7. Four different monodisperse test particles dispersed in water were analysed and their form factor f 802 as well as their optical diameter 809 and their hydrodynamic diameter 801 was determined. Since the particles are homogeneous and spherical, their hydrodynamic diameter is expected to be similar to their optically determined diameter as the latter is based on the assumption that they are homogeneous and spherical. In the plot in diagram B, the test particles are shown to have an expected relationship between their hydrodynamic diameter and form factor. The data points correspond to 170 nm diameter polystyrene 805, 210 nm diameter polystyrene 806, 240 nm diameter mesoporous silica 807 and 300 nm diameter solid silica 808.

Diagram A shows the relationship between hydrodynamic diameter 801 and optically determined diameter 809 for the four different particle types, showing a very high degree of correlation.

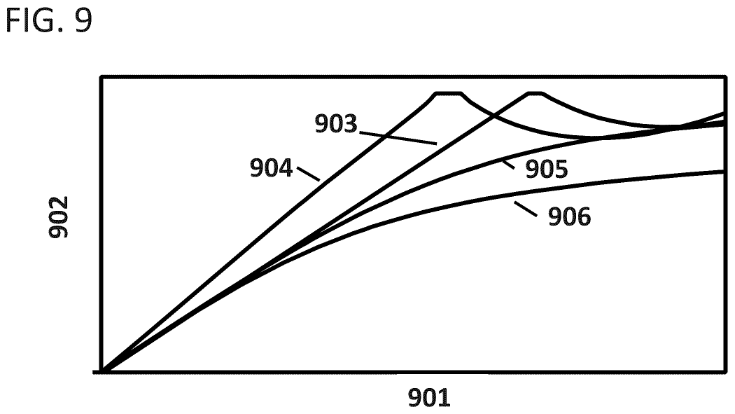

FIG. 9. Shows a theoretical plot of optically determined diameter 902 in relation to hydrodynamic diameter 901 for particles with different mass distribution and thus with different form factor for a given size. Curve 903 is homogeneous spherical particles, for which optical and hydrodynamic diameter is expected to be similar. Curve 904 is for core-shell particles with a very thin shell and with a core with the same refractive index as the surrounding medium. In this case all the mass is located as far from the center of the particle as possible. Since the optically determined diameter was calculated based on the assumption of a homogeneous sphere, the estimated diameter for the core-shell particle will be higher than the hydrodynamic diameter. For particles where the mass is located more at the center than at the outer parts, the optical diameter will be substantially smaller than the hydrodynamic diameter. This is the case for aggregates of smaller particles. It can also be the case for core-shell particles where the core has a higher refractive index than the shell. For example, a solid particle with a low density layer of attached molecules or nanoparticles on the surface. Curve 905 is expected for a particle aggregates with fractal dimension 2.5 and curve 906 is expected for aggregates with fractal dimension 1.3. For large particles the relations become complicated due the previously mentioned minima in the scattering intensity as a function of size. Nevertheless, aggregates with a fractal dimension of less than 2.5 can be differentiated form homogeneous particles. Furthermore, homogeneous spheres can often be differentiated from core-shell particles based on the low refractive index of the latter.

A practical application is for example to differentiate between core-shell particles such as extracellular vesicles and protein aggregates. Both have very low refractive index due to their low density and can therefore not readily be differentiated based on their refractive index. However, since their form factors are significantly different, this can be used to differentiate them.

### Example 2. Polystyrene Aggregates

Aggregates containing 70 nm diameter polystyrene spheres via salt-induced aggregation, where Dₒₚₜ was much smaller than Dh. These were analyzed using ISCAT and DHM using a set-up similar to FIG. 4. As the detected particles were mostly within the fractal dimension range of 1.3-2.1, this indicated either core-shell particles where the core is denser than the shell or fractal aggregates. The mean value of the obtained fractal dimension was around 1.7, which is close to the expected for salt-induced fractal aggregates in the case of cluster-cluster aggregation.

### Example 3. Protein Aggregates

Freeze-thawed fetal bovine serum was passed through a size exclusion chromatography column where the particle fraction was measured using a set-up similar to FIG. 4. Fetal bovine serum contains in addition to biomolecules also around 10\hat{ }9/ml particles, which includes many different particle types including extra-cellular vesicles, lipoprotein particles and protein aggregates, where some different particle types could be resolved. Similar to the salt-induced polystyrene particles in example 2, several of the particle detections agreed
well with a fractal dimension around 1.9. This indicates that the ability of the method to determine the presences of aggregates depends very weakly on the type of monomer making up the aggregates. There was also a fraction of particles close to the line of solid spheres. Given that the particles close the line for solid spheres have a refractive index of 1.36-1.37, where literature values for extracellular vesicles ranges from 1.36 to around 1.40, those detections likely correspond to extracellular vesicles.

1. A method for characterizing submicron and/or nanoparticles by the use of subwavelength interferometric microscopy, the method comprising:
illuminating a sample comprising at least one particle by light from a first light source in order to produce scattered light from the particle whereby a first portion of scattered light propagating from the at least one particle in a direction being deflected by an angle α relative the propagation direction of the incident light is directed towards a first detector;
using light from said first light source or a second light source for illuminating the sample in order to produce scattered light from the at least one particle whereby a second portion of scattered light propagating from the particle in a direction being deflected by an angle β relative the propagation direction of the incident light is directed towards the first detector or a second detector, and
the absolute value of said angle α and the absolute value of said angle β differ by at least 30 degrees, and
said first portion of scattered light is interfering with light originating from the first light source which is used to produce the first portion of scattered light when the first portion of light is detected at the first detector and said second portion of scattered light is interfering with light originating from the same light source which is used to produce the second portion of scattered light when the second portion of light is detected at the first or second detector; and
determining a first parameter indicative of scattering cross section of the at least one particle from the detected first portion of light and determining a second parameter indicative of scattering cross section of the at least one particle from the detected second portion of light.

2. The method according to claim 1, further comprising estimating a form factor f of the particle by using the ratio of the first parameter indicative of scattering cross section and the second parameter indicative of scattering cross section.

3. The method according to claim 1, further comprising estimating an optically determined diameter Dₒₚₜ of the at least one particle based on a known relationship between Dₒₚₜ and the ratio of the first parameter indicative of scattering cross section and the second parameter indicative of scattering cross section.

4. The method according to claim 1, wherein the absolute value of angle α and angle β differs at least by 60 degrees, more preferably at least 90 degrees.

5. The method according to claim 1, wherein the absolute value of angle α for the first portion of scattered light is between 0 and 20 degrees and the absolute value of angle β for the second portion of light is between 100 and 180 degrees.

6. The method according to claim 1, wherein the absolute value of angle β for the second portion of light is between 150 and 180 degrees.

7. The method according to claim 1, further comprising using digital holographic microscopy for analysing the first portion of scattered light.

8. The method according to claim 2, further comprising: determining an optically determined diameter Dₒₚₜ of the particle based on the determined form factor, in combination with a prediction based on the assumption that the particle is a homogeneous sphere;
determining a hydrodynamic diameter D_{hyd} by tracking the Brownian motion of the particle; and
using the ratio between the optically determined diameter Dₒₚₜ and the hydrodynamic diameter D_{hyd} to differentiate between particles of different morphology.

9. The method according to claim 3, further comprising identifying at least one parameter from parameter group I, wherein parameter group I comprises the parameters:
ratio of parameters indicative of scattering cross sections for the two imaging angles
form factor
optically determined diameter
and at least one parameter from parameter group II is identified, wherein parameter group II comprises the parameters:
Hydrodynamic diameter
parameter indicative of scattering cross section for either of the imaging angles
Scattering intensity for either imaging angle
Imaginary part of the complete optical field
Integrated phase shift
whereby at least one parameter from each one of parameter groups I and II are used to categorize detected particles into particle populations with different population density maxima in the parameter space of the said at least two parameters.

10. The method according to claim 8, further comprising estimating adsorption of a protein corona on a particle based on a change in relation between the hydrodynamic diameter D_{hyd} and optically determined diameter Dₒₚₜ before and after adsorption.

11. The method according to claim 8, further comprising estimating, for a population of particle aggregates, the fractal dimension of the particle aggregates based on how the ratio of the optically determined diameter Dₒₚₜ and the hydrodynamic diameter D_{hyd}, increases with hydrodynamic diameter.

12. The method according to claim 8 further comprising characterising dielectric particles labelled with plasmonic nanoparticles, wherein said plasmonic nanoparticles are resonant and strongly absorbing at a first wavelength used for the light source for the first portion of light, and non-resonant and weakly absorbing at a second wavelength used for the second light source for the second portion of light whereby
the first portion of light is used to determine the full optical field of the particle,
the optical field is used to differentiate labelled particles from other particles and particle complexes,
the imaginary part of the optical field is used as an approximation for the amplitude of the optical field of the dielectric particle less the attached plasmonic nanoparticles to estimate the scattering cross section of the dielectric particle less the attached plasmonic nanoparticles, and
the scattering cross section is used to determine an optically determined diameter for the dielectric particle less the attached plasmonic nanoparticles.

13. The method according to claim 8, further comprising differentiating exosomes from protein aggregates and/or lipoproteins.

14. The method according to claim 8, further comprising differentiating viable virus particles from virus debris, protein aggregates and/or exosomes.

15. The method according to claim 8, further comprising differentiating protein aggregates are differentiated from other particle types.

16. A subwavelength interferometric microscopy system for characterizing submicron and/or nanoparticles, the system comprising:
at least one light source configured to illuminate a sample comprising at least one particle to produce scattered light from the particle whereby a first portion of scattered light propagating from the at least one particle in a direction being deflected by an angle α relative the propagation direction of the incident light is directed towards at least one detector;
the at least one light source being further configured to illuminate the sample in order to produce scattered light from the at least one particle whereby a second portion of scattered light propagating from the particle in a direction being deflected by an angle β relative the propagation direction of the incident light is directed towards the at least one detector, and
the absolute value of said angle α and the absolute value of said angle β differ by at least 30 degrees, and said first portion of scattered light is interfering with light originating from a first light source which is used to produce the first portion of scattered light when the first portion of light is detected at the first detector and said second portion of scattered light is interfering with light originating from the first light source or a second light source which is used to produce the second portion of scattered light when the second portion of light is detected at the first or second detector; the system further comprising control circuitry configured to:
determine a first parameter indicative of scattering cross section of the at least one particle from the detected first portion of light and determine a second parameter indicative of scattering cross section of the at least one particle from the detected second portion of light.

17. The subwavelength interferometric microscopy system according to claim 16, wherein the absolute value of angle α for the first portion of scattered light is between 0 and 20 degrees and the absolute value of angle β for the second portion of light is between 100 and 180 degrees.

18. The subwavelength interferometric microscopy system according to claim 16, where a first light source is configured to illuminate the sample at an absolute angle of between 0-20 degrees, and a second light source is configured for interferometric scattering microscopy by illuminating the sample at an absolute angle of 100 to 180 degrees, the components arranged for interferometric scattering microscopy further comprising:
a light source for illumination of the sample;
a sample holder for holding the liquid sample comprising at least one particle;
a detector;
light from said light source being arranged such that light not scattered by the particle in the sample is reflected by the sample holder and/or a surface in close vicinity of the sample holder such that it reaches the detector and interferes at the detector with light scattered by the particle.

19. The subwavelength interferometric microscopy system according to claim 16, wherein the first light source is configured to illuminate the sample at an angle of between 0-20 degrees, and light from the first light source which passes the sample unscattered, is interfering at the detector with light from the first light source scattered by the at least one particle in the sample.

20. The subwavelength interferometric microscopy system according to claim 19 where the first light source is part of a digital holographic microscope arrangement, comprising:
a coherent light source for creating a base light beam for illuminating a sample in a first image plane,
a sample holder for holding a sample in the image plane to be illuminated,
a detector, e.g. a camera, arranged to record images of light transmitted through a sample in the sample holder,
an optical component for dividing the base light beam into different portions and causing the different portions of the light beam to interfere with each other at the detector.
